(19) United States
(12) Patent Application Publication
(10) Pub. No.: US 2023/0324431 A1
(43) Pub. Date: Oct. 12, 2023

(54) REAL-TIME SPEED ESTIMATION METHOD OF MOVING OBJECT

(71) Applicant: AKTIEBOLAGET SKF, Goteborg (SE)

(72) Inventors: Wenjun LI, Shanghai (CN); Haiyong HAN, Shanghai (CN); Xiaoyuan MA, Shanghai (CN); Gang CHENG, Shanghai (CN); Mark RHODES, South Queensferry (GB)

(21) Appl. No.: 18/130,551

(22) Filed: Apr. 4, 2023

(30) Foreign Application Priority Data
Apr. 12, 2022 (CN) 202210378821.3

(51) Int. Cl. G01P 7/00

(52) U.S. Cl. CPC G01P 7/00

(57) ABSTRACT

A method of estimating a speed of an object in real-time includes acquiring from an acceleration sensor mounted on the object a first original acceleration signal indicative of an acceleration of the object in a direction parallel to a travelling direction of the object, filtering the first original acceleration signal to remove noise to produce a first filtered acceleration signal, down-sampling the first filtered acceleration signal to obtain a first optimized acceleration signal, and calculating an estimated speed value of the object along the direction parallel to the travelling direction of the object based on the first optimized acceleration signal.

### CROSS-REFERENCE

This application claims priority to Chinese patent application no. 202210378821.3 filed on Apr. 12, 2022, the contents of which are fully incorporated herein by reference.

### TECHNICAL FIELD

The present disclosure is directed to a method for the real-time estimation of a speed of a moving object, which is implemented based on an acceleration signal from an acceleration sensor.

### BACKGROUND

For trains, subway trains, mining machinery and other machinery or vehicles that move relative to the ground, their speed needs to be detected frequently. In order to detect the malfunction of the rotary components, it is necessary to accurately estimate the vehicle speed in real-time when it is inconvenient to apply speed sensors. In addition, because the energy consumption and hardware cost of malfunction diagnosis products are relatively high, it is not a good choice to adopt the common solution using speed sensors to monitor the speed. Another method to detect speed in this field is the speed detection depending on GPS signal, but this method is not accurate and not real-time, and it is often impossible to detect speed when the GPS signal is not good.

### SUMMARY

The disclosed method estimates the speed of a moving object such as a vehicle in real time by synchronously sampling the bidirectional acceleration and analyzing the acceleration signal without relying on any speed sensor. The acceleration sensor is used to detect the movement of the moving object, capture the acceleration of the moving object, filter the vibration noise, get high-precision acceleration, and estimate the speed until it meets the requirements of status monitoring.

Therefore, embodiments of the disclosure provide a real-time speed estimation method of a moving object that includes: 1) acquiring a first original acceleration signal along a direction parallel to a travelling direction of the moving object from an acceleration sensor installed on the moving object, 2) filtering the first original acceleration signal to remove noise and obtaining a first filtered acceleration signal, 3) down-sampling the first filtered acceleration signal to obtain a first optimized acceleration signal, 4) calculating an estimated speed value of the moving object along the direction parallel to the travelling direction of the moving object based on the first optimized acceleration signal.

Advantages of the disclosed method include: 1) low power consumption for real-time speed estimation of the moving object in short-term malfunction diagnosis systems, 2) the direction identification of the moving object has higher speed accuracy than the speed estimation method based on global navigation satellite system, 3) it is especially suitable for subway speed estimation and in other locations, such as underground, where GPS signals are not easily available.

### BRIEF DESCRIPTION OF THE DRAWINGS

FIG. 1 is a schematic side elevational view of a portion of a vehicle that includes an acceleration sensor according to an embodiment of the present disclosure.

FIG. 2 is a graph that schematically shows an acceleration signal being processed by applying a sliding window according to an embodiment of the present disclosure.

FIG. 3 is a flowchart showing a method for estimating a speed of a moving object in real time according to an embodiment of the present disclosure.

### DETAILED DESCRIPTION

With reference to the drawings, a method for estimating a speed of a moving object in real-time according to the present disclosure will be described. It should be understood that in this description, the direction of movement is described with reference to the attached drawings and the general travelling direction of a moving object, such as the power machines/vehicles. For example, the direction parallel to the travelling direction of the moving object is set as the X direction (left and right direction in the attached drawings), and the direction, in the vertical plane, perpendicular to the X direction is set as the Z direction (up and down direction in the attached drawings).

The real-time speed estimation method of the present disclosure uses an output of an acceleration sensor installed on the moving object, which is at least a 2-axis acceleration sensor but which could also be a 3-axis or a 6-axis acceleration sensor, and can be installed at any suitable position on the moving object. Taking the train shown in FIG. 1 as an example, it can be installed on a chassis structure of a train like the acceleration sensor 1 or on a structure related to wheels like the acceleration sensor 2.

Based on the real-time acceleration signal from the acceleration sensor, the speed of the moving object can be estimated in real time by the real-time speed estimation method of the present invention. The method comprises the following steps:
step 1: acquiring a first original acceleration signal ãₓ (i.e., an acceleration signal along a direction parallel to the travelling direction of the moving object) from the acceleration sensor installed to the moving object;
step 2: filtering the first original acceleration signal ãₓ to remove noise and obtaining a first filtered acceleration signal āₓ;
step 3: down-sampling the first filtered acceleration signal āₓ to obtain a first optimized acceleration signal āₓ;
step 4: calculating an estimated speed value v of the moving object along the direction parallel to the travelling direction of the moving object based on the first optimized acceleration signal aₓ.

Specifically, in the above step 1, the real-time acceleration signal from the acceleration sensor can be obtained by a certain sampling interval, and the sampling interval can be set according to the actual application scenario, for example. In the above step 2, the first original acceleration signal ãₓ can be filtered by any suitable method, such as by infinite impulse response filtering, finite impulse response filtering and exponentially weighted average filtering. Noise in the first original acceleration signal ãₓ can be removed by filtering to obtain the first filtered acceleration signal āₓ. In step 3, the number of sampling points to be processed in subsequent steps can be reduced by down-sampling the first filtered acceleration signal āₓ, to optimize the calculation amount. Such down-sampling can be performed at any suitable frequency, for example, less than or equal to 500 Hz. In the above step 4, the estimated speed value v of the moving object a long a direction parallel to the travelling direction of the moving object can be calculated based on first optimized acceleration signal aₓ after the down-sampling and by an appropriate integration algorithm.

For example, assuming an initial speed of zero, if the acceleration signal indicates an acceleration of 1 m/s² for 10 seconds, the speed of the vehicle can be determined to be 10 m/s. If the acceleration signal then indicates a negative acceleration (an acceleration in a direction opposite to the direction of the first acceleration signal) of 1 m/s² for five seconds, the new speed of the vehicle can be calculated to be 5 m/s. An acceleration of zero will indicate a steady speed which may be positive, negative or zero. If the net positive and negative accelerations since the starting time are approximately zero and the measured acceleration remains zero for a given period of time, it can be assumed that the vehicle is stopped.

Through the method of the invention, the real-time calculation of the actual speed of the moving object can be realized based only the signal of the acceleration sensor without using a conventional speed sensor, a GPS signal or the like, thus providing a more convenient and reliable speed estimation method.

According to a further preferred embodiment of the present disclosure, step 1 may further include: setting a first sliding time window for the first original acceleration signal ãₓ, and determining a change trend based on the value of the first original acceleration signal in the first sliding time window to determine whether the moving object is in a stopped status (i.e., a status of being stopped relative to the ground). This determination can be realized, for example, in the following ways.

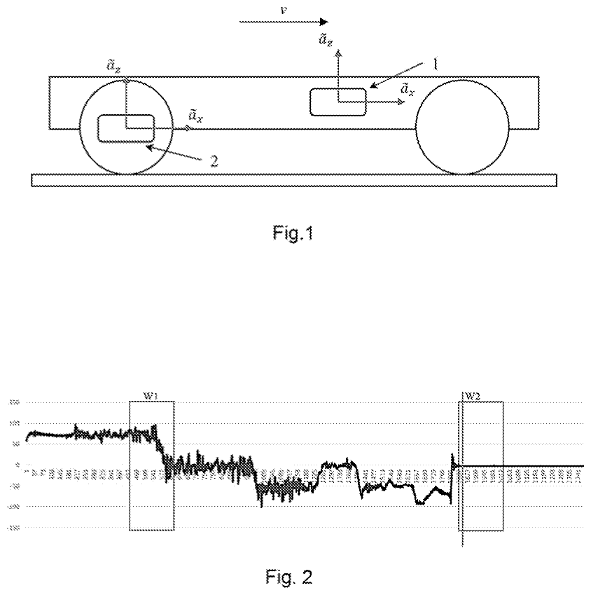

Referring to FIG. 2, the abscissa represents the sampling number of the acceleration sensor in the X direction and the ordinate represents the signal values of the first original acceleration signal ãₓ. A sliding time window (for example, a time window of 1-20 seconds) is applied to the sampled data, and the change trend of the acceleration signal value in this time window is determined to determine whether the moving object is in a stopped status. For example, in the time window W1 on the left, it is observed that the acceleration signal changes in a wide range, and it can be determined that the moving object is not in a stopped status; while, when it is observed that the acceleration signal changes little or fluctuates only in a small range in the time window W2 on the right, it can be determined that the moving object has stopped. For example, starting from the vertical straight line at the time window W2 in FIG. 2, the moving object turns into a stopped status.

Specifically, according to a preferred embodiment of the present disclosure, it can be determined whether the moving object is in a stopped status based on whether an absolute value of the difference between a peak value and an average value of the first original acceleration signal within the first sliding time window is less than or equal to a first threshold, as defined by the following formula:

absolute value(peak value−average value)≤the first threshold.

In addition, in some cases, due to the characteristics of the acceleration sensor, the acceleration sensor may have some deviation after the moving object moves multiple times and the acceleration sensor measures multiple times. Therefore, for every new real-time speed estimate starting from a stopped status, this initial deviation should be eliminated to improve the accuracy of speed estimation. Therefore, according to a preferred embodiment of the present invention, after determining that the moving object is in a stopped status, an average value of the first original acceleration signal ãₓ in a period of time can be calculated to be a first initial deviation. And if the first initial deviation is calculated, step 3 may further include: after down-sampling the first filtered acceleration signal āₓ, subtracting the first initial deviation to obtain a first optimized acceleration signal aₓ so that a more accurate speed estimation result can be obtained by calculating the speed by using the optimized acceleration signal value after subtracting the initial deviation.

According to a further preferred embodiment, in the real-time speed estimation method, a step 3.5 may be further included between step 3 and step 4, which includes: setting a second sliding time window for the first optimized acceleration signal aₓ, and determining its change trend based on the value of the first optimized acceleration signal aₓ in the second sliding time window to determine whether the moving object is in a startup status (i.e., a status of getting started to move relative to the ground). Specifically, the determination of the change trend of the first optimized acceleration signal aₓ can be implemented by any suitable method. According to a preferred embodiment of the present invention, whether the moving object is in the startup status can be determined based on whether the absolute value of the difference between a peak value and an average value of the first optimized acceleration signal aₓ in the second sliding time window is greater than a second threshold, as defined by the following formula:

absolute value(peak value−average value)>second threshold

Further preferably, after it is determined that the moving object is not in the startup status, steps 2 to 3.5 can be repeatedly executed until it is determined that the moving object is in a startup status. For example, in the case of a subway train, whether the subway train enters a start status from a stopped status can be monitored by repeatedly executing the above steps 2 to 3.5 of the method of the present invention, and the subsequent steps of the method of the present invention can be continued after it is determined that the subway train has entered the start status to estimate the real-time speed of the train after the train is in movement.

Further preferably, after determining that the moving object is in the startup status, the travelling direction of the moving object can be determined, based on a vector difference between the peak value and the average value of the first optimized acceleration signal aₓ in the second sliding time window and the direction of the reference frame of the acceleration sensor. Generally, for an acceleration sensor, it has its own reference frame and its sensing signal is also a vector value that indicates the direction (as shown in FIG. 2, the sensing signal of the acceleration sensor has its positive and negative values). Therefore, according to a preferred embodiment of the present invention, the travelling direction of the moving object can be determined as below:

(peak value−average value)>zero

Therefore, when the result of the above formula is greater than zero, it can be determined that the moving object is moving in a forward direction.

According to another preferred embodiment of the present disclosure, in order to further improve the accuracy of speed estimation, processing for a second acceleration along a direction perpendicular to the travelling direction of the moving object is also performed.

Specifically, in the above method, step 1 further includes synchronously acquiring (i.e., synchronous with the acquisition of the first original acceleration signal ãₓ) a second original acceleration signal ã_{z} along a direction perpendicular to the travelling direction of the moving object from the acceleration sensor installed to the moving object and calculating a second initial deviation based on the second original acceleration signal ã_{z}. According to the preferred embodiment, for example, the second initial deviation can be calculated in any suitable way, and preferably, the first initial deviation and the second initial deviation can be calculated in the same way.

Furthermore, step 2 includes filtering the second original acceleration signal ã_{z} to remove noise and obtain a second filtered acceleration signal ā_{z}. In this regard, the second original acceleration signal ã_{z} can be filtered in any suitable way, such as infinite impulse response filtering, finite impulse response filtering and exponentially weighted average filtering as mentioned above.

Furthermore, step 3 further includes down-sampling the second filtered acceleration signal ā_{z} and subtracting a second initial deviation to obtain a second optimized acceleration signal a_{z}. The second filtered acceleration signal ā_{z} may be sampled at the same frequency as the down-sampling of the first filtered acceleration signal āₓ, for example, less than or equal to 500 Hz.

Further preferably, in some cases, during the movement of the moving object, an impact signal (noise) may be generated in the acceleration sensor due to the sudden change of environment, road conditions and other factors (such as uneven road surface, track joints, etc.), which will also affect the calculation of the moving speed of the moving object, resulting in errors in the calculation of the speed along the travelling direction. Moreover, in the case of impact, great noises may be observed in the direction (that is, in the Z direction) perpendicular to the travelling direction (X direction) of the moving object. Therefore, the present invention proposes to eliminate or minimize the speed error in the X direction by using the noise observed in the Z direction. Therefore, step 4 further includes: calculating the measured noise based on the second optimized acceleration signal a_{z}, and adjusting the calculation of the speed estimation value based on the measured noise. For example, when calculating an acceleration estimation value and a velocity estimation value by using Kalman filtering based on a first optimized acceleration signal (which is a current measured value in Kalman filtering), a second optimized acceleration signal a_{z} may be collected, and measured noise may be determined based on the amplitude of the second optimized acceleration signal a_{z}. For example, when it is calculated that the amplitude of the second optimized acceleration signal a_{z} is large, it can be determined that the current measured noise is large. At this time, the internal parameters of the Kalman filter function can be adjusted to reduce the dependence of the estimation result on the current measured value, and then the acceleration estimation value and the speed estimation value in the X direction obtained based on the Kalman filter can be adjusted, so that the acceleration estimation value can better reflect the actual acceleration and the speed estimation value in the X direction is more accurate to eliminate the influence of the impact.

In addition, according to the inventor's observation and research, for some specific applications, when the estimated speed value is less than a predetermined minimum speed limit, the estimated speed value is not accurate or difficult to be used for subsequent processing.

Therefore, according to a further preferred embodiment of the present disclosure, the method of the present invention may further include: comparing the estimated speed value obtained in step 4 with a preset minimum limit speed, taking the estimated speed value greater than the minimum limit speed as a target speed, then determining the speed change rate of the target speed, and taking the target speed as a steady speed if the speed change rate is less than the preset speed change rate, and outputting the steady speed. This steady speed can be used for subsequent processing, for example, and can also be displayed to users as real-time speed.

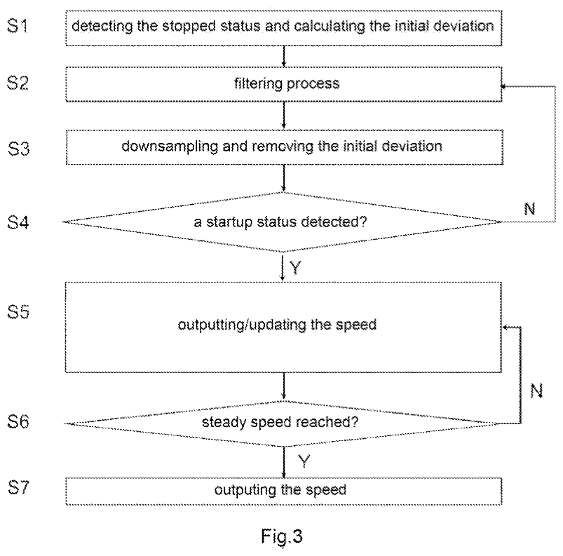

FIG. 3 shows a speed prediction method according to a preferred embodiment of the present disclosure, which incorporates some preferred steps as described above to realize stable and accurate real-time speed estimation based on signals from acceleration sensors in X direction and Z direction.

Starting from step S1, the method synchronously acquires, from an acceleration sensor installed on the moving object, a first original acceleration signal ãₓ along the direction parallel with the travelling direction of the moving object and a second original acceleration signal ã_{z} along the direction perpendicular to the travelling direction of the moving object, and then, according to the above method, detects whether the moving object is in a stopped status by applying a sliding time window to ãₓ, and calculates the initial deviations of the first original acceleration signal ãₓ and the second original acceleration signal ã_{z};

In step S2, the first original acceleration signal ãₓ and the second original acceleration signal ã_{z} are filtered to remove high-frequency noise in the acceleration signals to obtain a first filtered acceleration signal āₓ and a second filtered acceleration signal ā_{z};

In step S3, the first filtered acceleration signal āₓ and the second filtered acceleration signal ā_{z} are down-sampled and their respective initial deviations are subtracted to thereby obtain a first optimized acceleration signal aₓ and a second optimized acceleration signal a_{z};

In step S4, a second sliding time window is set for the first optimized acceleration signal aₓ to determine whether the moving object is in a startup status, and if it is determined that the moving object is not in a startup status, steps S2-S4 are executed repeatedly; if it is determined that the moving object is in a startup status, the method proceeds to step S5;

In step S5, the speed estimation value v of the moving object along the direction parallel to the travelling direction of the moving object is calculated based on the first optimized acceleration signal aₓ;

In step S6, the estimated speed value v is compared with the preset minimum limit speed, and the estimated speed value v greater than the minimum limit speed is taken as a target speed, then the speed change rate of the target speed is determined, and it is determined whether the speed change rate is less than the preset speed change rate, to determine whether a steady speed has been reached; when the steady speed has not been reached, the method returns to step S5; when the steady speed has been reached, the method proceeds to step S7;

In step S7, the steady speed is output for subsequent processing.

The exemplary implementation of the scheme proposed in this disclosure has been described in detail above with reference to the preferable embodiments. However, it can be understood by those skilled in the art that without departing from the concept of this disclosure, various changes and modifications can be made to the above specific embodiments, and various technical features and structures proposed in this disclosure can be combined in various ways without exceeding the scope of protection of this disclosure, which is determined by the appended claims.

Representative, non-limiting examples of the present invention were described above in detail with reference to the attached drawings. This detailed description is merely intended to teach a person of skill in the art further details for practicing preferred aspects of the present teachings and is not intended to limit the scope of the invention. Furthermore, each of the additional features and teachings disclosed above may be utilized separately or in conjunction with other features and teachings to provide improved methods of real-time speed estimation.

Moreover, combinations of features and steps disclosed in the above detailed description may not be necessary to practice the invention in the broadest sense, and are instead taught merely to particularly describe representative examples of the invention. Furthermore, various features of the above-described representative examples, as well as the various independent and dependent claims below, may be combined in ways that are not specifically and explicitly enumerated in order to provide additional useful embodiments of the present teachings.

All features disclosed in the description and/or the claims are intended to be disclosed separately and independently from each other for the purpose of original written disclosure, as well as for the purpose of restricting the claimed subject matter, independent of the compositions of the features in the embodiments and/or the claims. In addition, all value ranges or indications of groups of entities are intended to disclose every possible intermediate value or intermediate entity for the purpose of original written disclosure, as well as for the purpose of restricting the claimed subject matter.

What is claimed is:

1. A method of estimating a speed of an object in real-time comprising:
acquiring from an acceleration sensor mounted on the object a first original acceleration signal indicative of an acceleration of the object in a direction parallel to a travelling direction of the object;
filtering the first original acceleration signal to remove noise to produce a first filtered acceleration signal;
down-sampling the first filtered acceleration signal to obtain a first optimized acceleration signal; and
calculating an estimated speed value of the object along the direction parallel to the travelling direction based on the first optimized acceleration signal.

2. The method according to claim 1, further including:
setting a first sliding time window for the first original acceleration signal,
determining a change trend of a value of the first original acceleration signal in the first sliding time window, and
determining whether the object is in a stopped status from the change trend.

3. The method according to claim 1, further including:
determining whether the object is in a stopped status based on whether an absolute value of a difference between a peak value of the first original acceleration signal and an average value of the first original acceleration signal within the first sliding time window is less than or equal to a first threshold.

4. The method according to claim 2, further including:
calculating an average value of the first original acceleration signal in a period of time to be a first initial deviation after determining that the object is in a stopped status,
wherein obtaining the first optimized acceleration signal includes: after down-sampling the first filtered acceleration signal, subtracting the first initial deviation from the first filtered acceleration signal.

5. The method according to claim 1,
further comprising, after obtaining the first optimized acceleration signal and before calculating the speed estimation value,
setting a second sliding time window for the first optimized acceleration signal,
determining a change trend of the value of the first optimized acceleration signal in the second sliding time window, and
determining whether the object is in a startup status based on the change trend.

6. The method according to claim 5, further including:
determining whether the object is in a startup status based on whether an absolute value of a difference between a peak value of the first optimized acceleration signal in the second sliding time window and an average value of the first optimized acceleration signal in the second sliding time window is greater than a second threshold.

7. The method according to claim 6, further including:
if the object is not in the startup status, repeatedly: a) obtaining the first filtered acceleration signal, b) obtaining the first optimized acceleration signal and c) determining whether the object is in the startup status, until it is determined that the object is in the startup status.

8. The method according to claim 6, further including:
if the object is in the startup status, determining a travelling direction of the object based on a vector difference between a peak value of the first optimized acceleration signal in the second sliding time window and an average value of the first optimized acceleration signal in the second sliding time window and a direction of a reference frame of the acceleration sensor.

9. The method according to claim 1, further including:
synchronously acquiring from the acceleration sensor a second original acceleration signal along a direction perpendicular to the travelling direction of the object;
calculating a second initial deviation based on the second original acceleration signal;
filtering the second original acceleration signal to remove noise and obtain a second filtered acceleration signal;
down-sampling the second filtered acceleration signal and subtracting the second initial deviation to obtain a second optimized acceleration signal;
calculating a measured noise based on the second optimized acceleration signal, and
adjusting the estimated speed value based on the measured noise.

10. The method according to claim 1, further comprising:
comparing the estimated speed value with a preset minimum limit speed,
taking the estimated speed value greater than the minimum limit speed as a target speed;
determining a speed change rate of the target speed,
taking the target speed as a steady speed when the speed change rate is less than a preset speed change rate, and
outputting the steady speed.
